(19) United States
(12) Patent Application Publication
(10) Pub. No.: US 2009/0271564 A1
(43) Pub. Date: Oct. 29, 2009

(54) STORAGE SYSTEM

(75) Inventors: Sadahiro SUGIMOTO, Yokohama (JP); Akira YAMAMOTO, Sagamihara (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/175,664

(22) Filed: Jul. 18, 2008

(30) Foreign Application Priority Data
Apr. 25, 2008 (JP) 2008-114773

(51) Int. Cl. G06F 12/00

(52) U.S. Cl. 711/103

(57) ABSTRACT

A storage system has a storage controller and a flash memory module that is coupled to the storage controller. The storage controller manages the status of a storage area in a flash memory chip of the flash memory module. When a portion of the storage area in the flash memory chip becomes unwritable, the storage controller carries out control so as to use a free storage area as an alternate area for the unwritable storage area, and to store data that has been stored in the unwritable storage area, in the alternate area.

### CROSS-REFERENCE TO PRIOR APPLICATION

This application relates to and claims the benefit of priority from Japanese Patent Application number 2008-114773, filed on Apr. 25, 2008 the entire disclosure of which is incorporated herein by reference.

### BACKGROUND

The present invention generally relates to a storage system, and more particularly to a storage system that uses a nonvolatile semiconductor memory such as a flash memory.

Storage devices that use flash memory and other such nonvolatile semiconductor memory in place of conventional hard disk devices have been attracting attention in recent years. Compared to a hard disk, a flash memory has the advantages of being able to operate at high speed and consuming less power, but, on the other hand, flash memory also has the following restrictions. First, the updating of the respective bits of memory is limited to one direction, that is, from ‘1’ to ‘0’ (or from ‘0’ to ‘1’). When a reverse change is required, it is necessary to delete a memory block (hereinafter called the “block”) and make the entire block ‘1’s (or ‘0’s) one time. Further, there is a limit to the number of times this deletion operation can be carried out, and in the case of a NAND-type flash memory, for example, this limit is somewhere between 10,000 and 100,000 times.

Thus, connecting a flash memory to a computer in place of a hard disk device runs the risk of the write frequency bias of each block resulting in only a portion of the blocks reaching the limit for number of deletions and becoming unusable. For example, since the blocks allocated to the directory or inode have a higher rewrite frequency than the other blocks in an ordinary file system, there is a high likelihood that only these blocks will reach the limit for number of deletions.

With regard to this problem, a technique that extends the life of a storage device by allocating an alternate memory area (alternate block) to a memory area that has become unusable (a bad block) as disclosed in Japanese Patent Laid-open No. 5-204561 is known.

### SUMMARY

However, applying the technique disclosed in Japanese Patent Laid-open No. 5-204561 does not make it possible to extend the life of a storage device indefinitely, and when the memory areas, which were provided beforehand in the storage device, and which are capable of being allocated as alternate blocks run out, the storage device will reach the end of its service life.

When configuring a storage system using a storage device that makes use of a flash memory like this in place of a hard disk, a storage device that has reached the end of its service like must be replaced with a new storage device. Because of the bias in the frequency of writes from the host computer, it can be assumed that a large number of usable blocks remain in a storage device that has reached the end of its life, but these usable blocks are discarded at replacement time, resulting in this portion of the flash memory capacity being wasted. Furthermore, the need to replace a semiconductor disk can be eliminated by mounting beforehand in the storage device the maximum amount of spare blocks capable of being used as alternate blocks while the storage system is in operation, but in addition to the increase in initial costs, the concern is that these spare blocks will not be completely used up during actual operation, and thus become a waste.

Therefore an object of the present invention is to reduce the waste described hereinabove.

The storage system has a storage controller, and a flash memory module that is coupled to the storage controller. The storage controller manages the status of the storage area in a flash memory chip of the flash memory module. When it becomes impossible to write to a portion of the storage area in the flash memory chip, the storage controller exercises control such that a free storage area is used as an alternate area for a storage area that has become unwritable, and the data stored in the unwritable storage area is stored in the alternate area.

### BRIEF DESCRIPTION OF THE DRAWINGS

FIG. 1 is a diagram showing an example of the configuration of a storage system;

FIG. 2 is a diagram showing an example of block management information in a first embodiment;

FIG. 3 is a diagram showing an example of an alternate block allocation method of the first embodiment;

FIG. 4 is a diagram showing an example of a management server GUI of the first embodiment;

FIG. 5 is a flowchart showing an example of a process in which the management server of the first embodiment checks the free block capacity in the storage system, and displays a warning message;

FIG. 6 is a flowchart showing an example of a process in which a microprocessor of a storage device of the first embodiment checks the free block capacity and sends a warning message to the management server;

FIG. 7 is a conceptual view showing an example of a RAID1 configuration in a second embodiment;

FIG. 8 is a diagram showing an example of an alternate block allocation method of the second embodiment;

FIG. 9 is a diagram showing an example of a management server GUI of the second embodiment;

FIG. 10 is a diagram showing an example of block management information in the second embodiment;

FIG. 11 is a flowchart showing an example of a destage process of the second embodiment;

FIG. 12 is a flowchart showing an example of a rebuild process of the second embodiment; and

FIG. 13 is a conceptual view showing an example of a RAID5 configuration.

### DESCRIPTION OF THE PREFERRED EMBODIMENTS

An example of an embodiment of the present invention will be explained below while referring to the figures.

### Embodiment 1

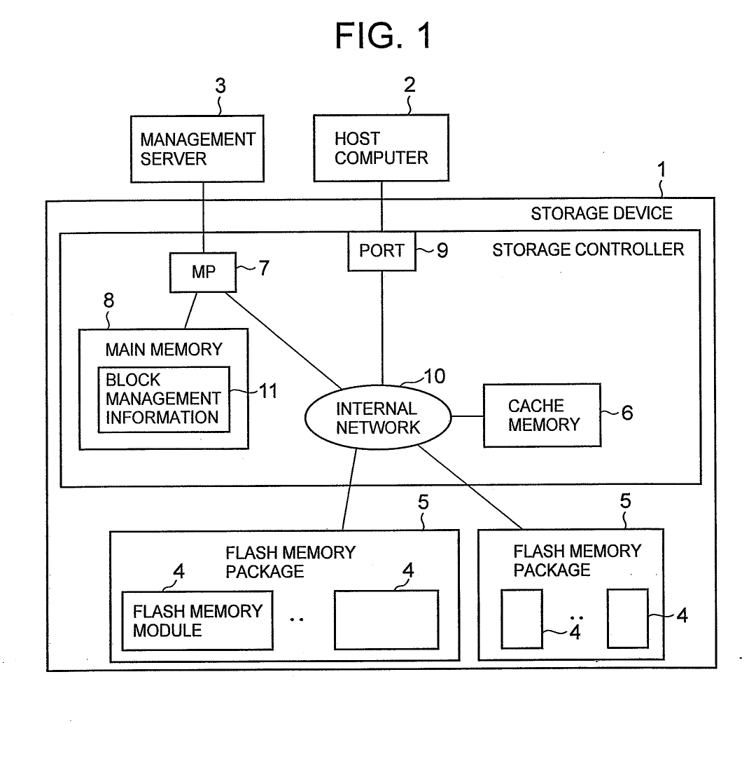

FIG. 1 is a diagram showing an example of the configuration of a storage system.

The storage system 1, for example, is a storage device comprising a plurality of flash memory modules. A host computer 2, which is one type of higher-level device, and which issues an I/O request, and a management server 3, which is a computer for managing the storage system 1, are coupled to the storage system 1. The storage system 1 has a plurality of flash memory modules 4 that store storage controllers and data; and one or a plurality of flash memory packages 5 capable of mounting a plurality of flash memory modules. The storage controller comprises a cache memory 6, which is a memory for caching data; one or more microprocessors (hereinafter notated as MP) 7 for controlling the storage system 1; a main memory 8 that holds data and programs for carrying out control; one or more ports 9 for exchanging data with the host computer 2; and an internal network 10 that interconnects the flash memory package 5, cache memory 6, port 9 and MP 7.

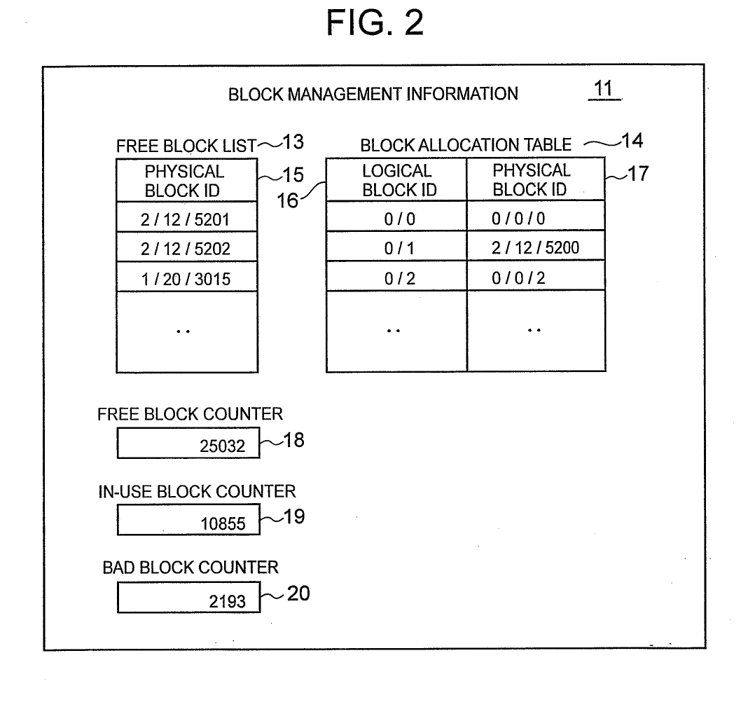

The flash memory module, for example, is a memory module, which is shaped like a DIMM (Dual Inline Memory Module), and which mounts a plurality of flash memory chips on a printed circuit board. Further, the flash memory package 5, for example, is a substrate comprising one or more slots for connecting a flash memory module 4; a control unit (LSI) for controlling access to a flash memory chip in the flash memory module 4; and a connector for connecting to the internal network 10 of the storage system. The main memory 8 stores block management information 11 for managing at least the blocks of a flash memory. An example of block management information 11 is shown in FIG. 2.

The block management information 11 comprises a free block list 13; block allocation table 14; free block counter 18; in-use block counter 19; and bad block counter 20. An in-use block here is one that is allocated as a data storage area, and comprises an alternate block. Further, a bad block is a block that has reached the limit for number of deletions, and is a block that cannot be used for fear of causing other failures. Furthermore, data cannot be written to a block that has reached the limit for number of deletions and has become of bad block, but it is possible to read data from this block. A free block is a block other than the ones just described, that is, a free block is one that is usable and, in addition, is not being used.

The free block list 13 lists up the physical block IDs 15 of free blocks. The physical block ID 15 is an identifier for uniquely specifying a block in the storage system, and, for example, is expressed as a combination of a flash memory package number, a flash memory module number in the flash memory package, and a block number in the flash memory module.

The block allocation table 14 is a mapping table of logical block IDs 16 that denotes the location of blocks in a logical address space, and the physical block IDs 17 of the blocks allocated to this logical block. The logical block ID 16, for example, is a combination of a device number and a block number in the device. The in-device block number, for example, is the quotient arrived at by dividing the addresses in the device by the block size.

The free block counter 18, in-use block counter 19 and bad block counter 20 are counters for respectively storing the number of free blocks, the number of used blocks, and the number of bad blocks in the storage system.

For example, when a block is allocated anew as a data storage area, the MP7 decrements the free block counter 18 by 1, and increments the in-use block counter 19 by 1. Further, when one block becomes unusable, and a free block is allocated as an alternate block, the MP7 increments the bad block counter 20 by 1 and decrements the free block counter 18 by 1.

Next, the alternate block allocation method will be described. In this embodiment, when a bad block occurs, the storage controller allocates a free block as an alternate block, and when data had been stored in the original block, which became a bad block, the storage controller moves this data to the alternate block. Furthermore, when a bad block occurs due to a failure, it may not be possible to read the data from the original block. In this case, for example, when a RAID (Redundant Arrays of Independent Disks) configuration is employed, the storage controller can use data and parity stored in another flash memory or magnetic disk to restore the data stored in the original block and write this data to the alternate block. Further, if it is backup data, the storage controller can copy the backup data to the alternate block. A configuration, which uses a plurality of flash memory packages 5 and forms a RAID configuration, will given as an example of the configuration of a second embodiment further below.

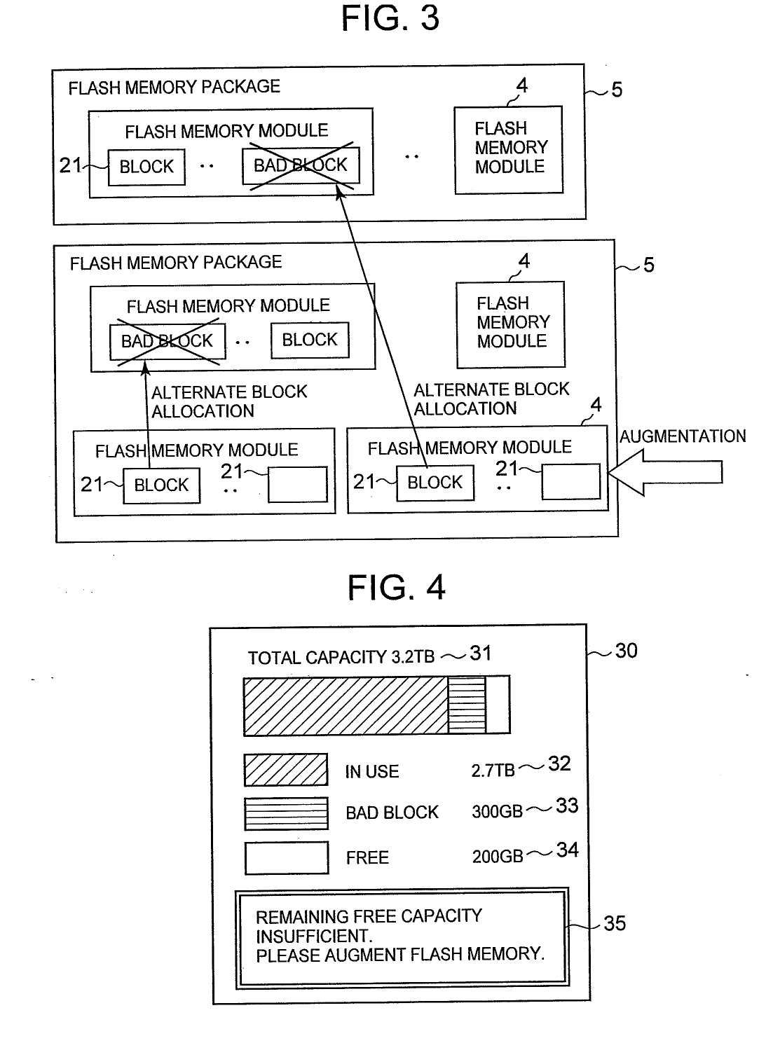

In this embodiment, since control of all the flash memories in the storage system is carried out by the MP7 of the main storage device, as shown in FIG. 3, it becomes possible to allocate an arbitrary free block in the storage system as an alternate block. That is, like the example disclosed in FIG. 3, a block in a flash memory module that differs from the flash memory module to which the bad block belongs can be used as the alternate block, and a block in a flash memory module connected to a flash memory package that differs from the flash memory package connected to the flash memory module to which the bad block belongs can be used as the alternate block. Although not shown in the figure, an alternate block can also be selected from inside the flash memory module to which the bad block belongs. Furthermore, when a flash memory module 4 is augmented, the MP7 registers the block of the augmented flash memory module in the free block list 13, and increases the value of the free block counter 18 by the number of blocks that were added. Thereafter, when allocating an alternate block, a block registered in the free block list 13 can be allocated. Next, managing the free block capacity will be explained.

When there are no more free blocks in the storage system, it becomes impossible to allocate a free block as an alternate block when a bad block occurs. Accordingly, the MP7 manages the free block capacity in the system, issues a warning when the remaining free block capacity is insufficient, and urges the administrator to augment flash memory.

FIG. 4 is an example of a GUI (Graphical User Interface) for managing the flash memory capacity in the storage system.

This GUI respectively displays the total capacity 31 of the flash memory mounted in the storage system 1; the total capacity 32 of the data-storing blocks (used) thereamong; the total capacity of the bad blocks 33; and the total capacity of the free blocks (free capacity) 34. Then, when the free capacity becomes insufficient, the GUI displays a message to that effect as a warning message in the message display area 35. Furthermore, means for issuing a warning are not limited to a warning message, and, for example, electronic mail or a syslog can also be used.

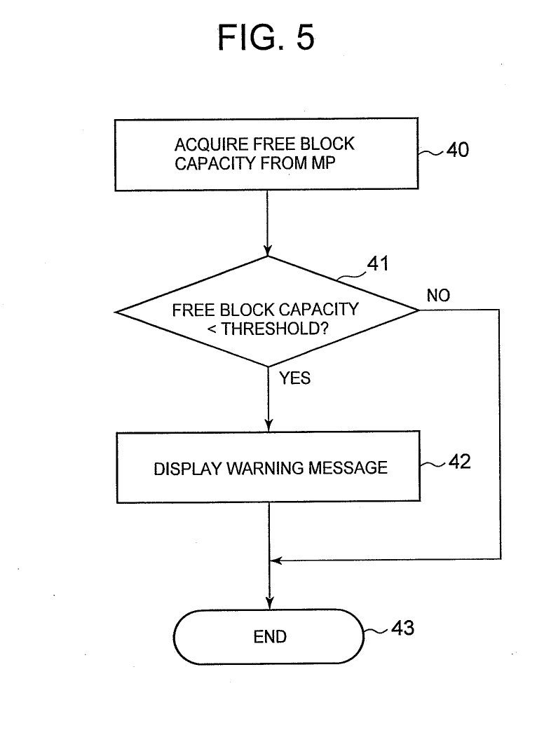

Next, FIG. 5 shows an example of a process in which the management server 3 checks the free block capacity 34 in the storage system, and displays a warning message. First, the management server 3 acquires the free block capacity 34 in the storage system from the MP7 (Step 40). Next, the management server 3 determines whether or not the free block capacity 34 is smaller than a predetermined threshold (Step 41). When the result of this determination is that the free block capacity 34 is smaller than the threshold, the management server 3 displays a warning message (Step 42), and ends processing (Step 43). When the free block capacity 34 is not smaller than the threshold (that is, when the free block capacity 34 is the threshold or greater), the management server 3 ends processing as-is.

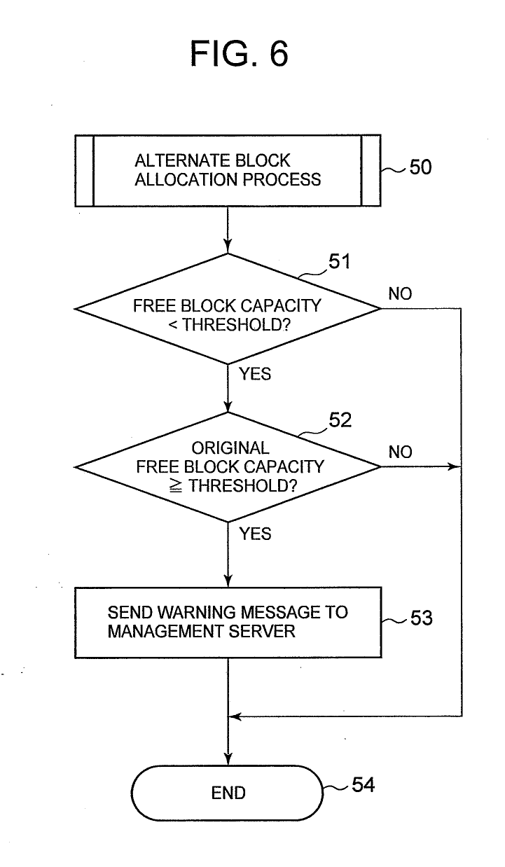

Furthermore, for example, a configuration in which the MP7 of the storage device independently checks the free block capacity 34, and sends a warning message to the management server 3 can also be used. The flowchart of FIG. 6 shows an example of the processing at that time. The MP7, after carrying out an alternate block allocation process (Step 50), determines whether or not the free block capacity 34 is smaller than the threshold (Step 51). When the free block capacity 34 is smaller than the threshold, the MP7 determines whether or not the free block capacity 34 was the threshold or greater prior to the alternate block allocation process (Step 52), and if this is true, sends a warning message to the management server 3 (Step 53). Furthermore, Step 52 is a determination for preventing the warning message from being sent repeatedly.

### Embodiment 2

A second embodiment of the present invention will be explained next.

The configuration of the storage system 1 in this embodiment is the same as in the first embodiment, and an example of this configuration is shown in FIG. 1.

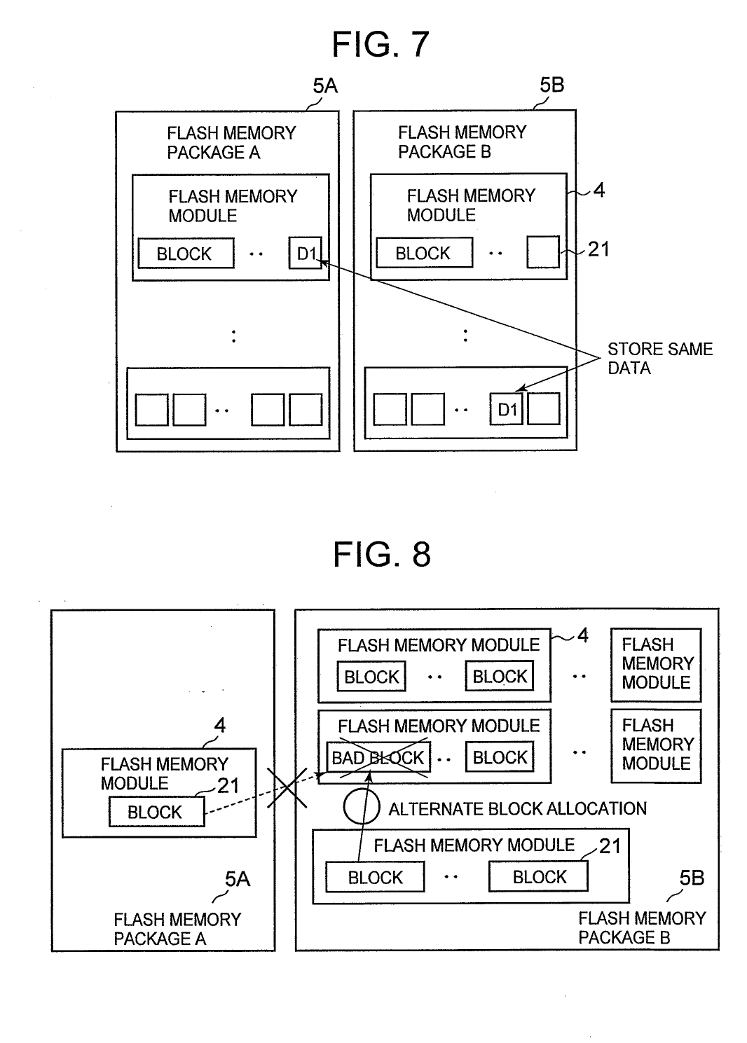

As described for the first embodiment, the allocation of an alternate block for the storage system 1 can be carried out for an arbitrary block in the storage system 1, but in this embodiment, the alternate block allocation range is limited to improve the reliability of the system. As one example, a case in which a plurality of flash memory packages 5 are configured into a RAID system in preparation for a flash memory package 5 failure will be considered. As an example, it is supposed here that two flash memory packages 5 are used, and that a RAID1 (mirroring) configuration, which stores the same data in two blocks in different flash memory packages 5, is formed as in FIG. 7.

In this case, since the redundancy for package failure is lost when the two blocks that store the same data constituting the mirror pair are arranged in the same package, when allocating an alternate block to a certain block, a free block in the same package as the original block is allocated as the alternate block as in FIG. 8.

As described hereinabove, the alternate block allocation range is limited in this embodiment, but since an alternate block can be allocated between flash memory modules 4, the augmentation units, a usable block can continue to be used as-is even when bad blocks increase and a flash memory module is augmented, achieving the efficient use of flash memory capacity effect in this embodiment as well.

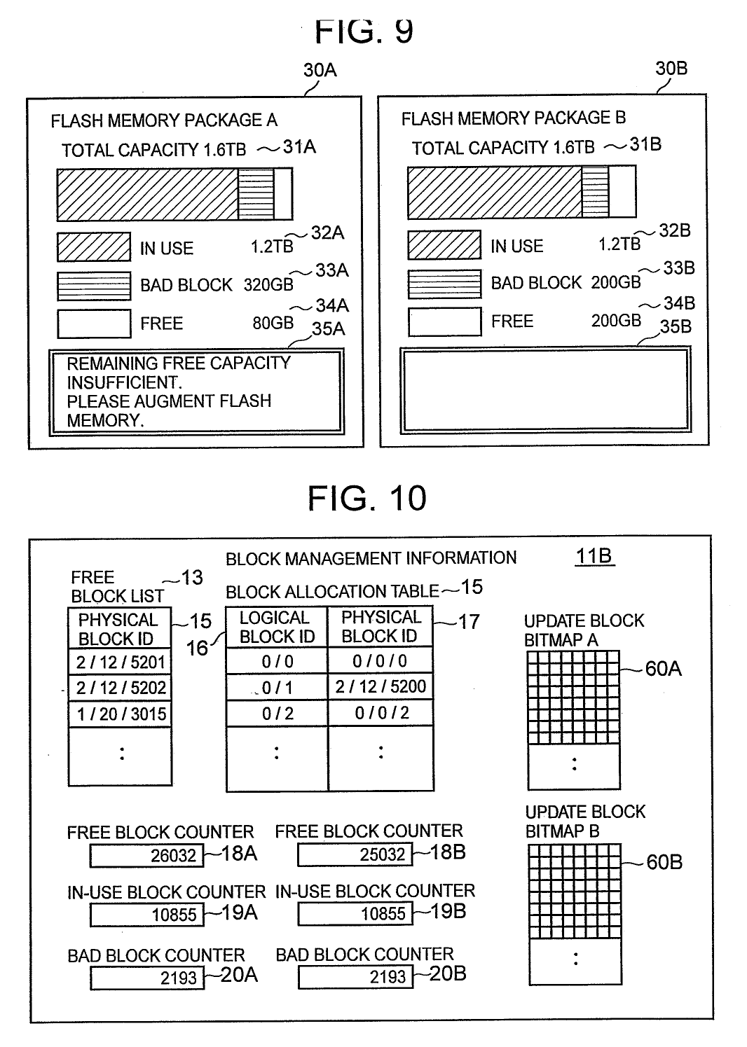

FIG. 9 shows an example of a GUI of this embodiment. Since the allocation of an alternate block is limited to the inside of the flash memory package, the management of flash memory capacity is carried out by each flash memory package. Then, the warning message when the remaining free block capacity becomes insufficient is outputted for each flash memory package. In FIG. 9, since the remaining free block capacity 34A in flash memory package A has become insufficient, a warning message is displayed in the message display area 35A.

Furthermore, in this embodiment, it is possible to remove the flash memory packages 5 one by one from the storage device, and to augment the flash memory modules 4 in the flash memory packages 5 while the system is in operation.

For example, when augmenting a flash memory module 4 in flash memory package A (5A), if a read command targeting an address corresponding to data D1 is received from the host computer 2 while blocking and removing the flash memory package A (5A) from the storage device, the MP7 can read the data D1 in flash memory package B (5B) and send this data D1 to the host computer 2. Further, when a write command targeting an address corresponding to data D1 is received from the host computer 2, and this data D1 is written to flash memory, the MP7 can update the data D1 in flash memory package B (5B) using the data received from the host computer 2. Then, when memory module augmentation ends, and flash memory package A (5A) is reinstalled in the storage device, the MP7 can copy the data of the respective blocks in flash memory package B (5B) to blocks that constitute the mirror pairs in flash memory package A (5A), that is, the MP7 can execute a rebuild process.

Furthermore, since the original data remains in flash memory package A (5A) at this time, it is not always necessary to rebuild flash memory package A (5A) in its entirety. For example, the MP7 can shorten rebuild time by using a bitmap or the like to record blocks corresponding to addresses for which a write has been carried out during flash memory augmentation, and then only rebuilding these blocks. FIG. 10 shows an example of block management information 11B, which adds an update block bitmap showing the presence or absence of a write to the respective blocks. Update block bitmap A (60A) is the update block bitmap for flash memory package A, and update block bitmap B (60B) is the update block bitmap for flash memory package B. Furthermore, different counters are used in flash memory package A and flash memory package B for the free block counter 18, in-use block counter 19 and bad block counter 20.

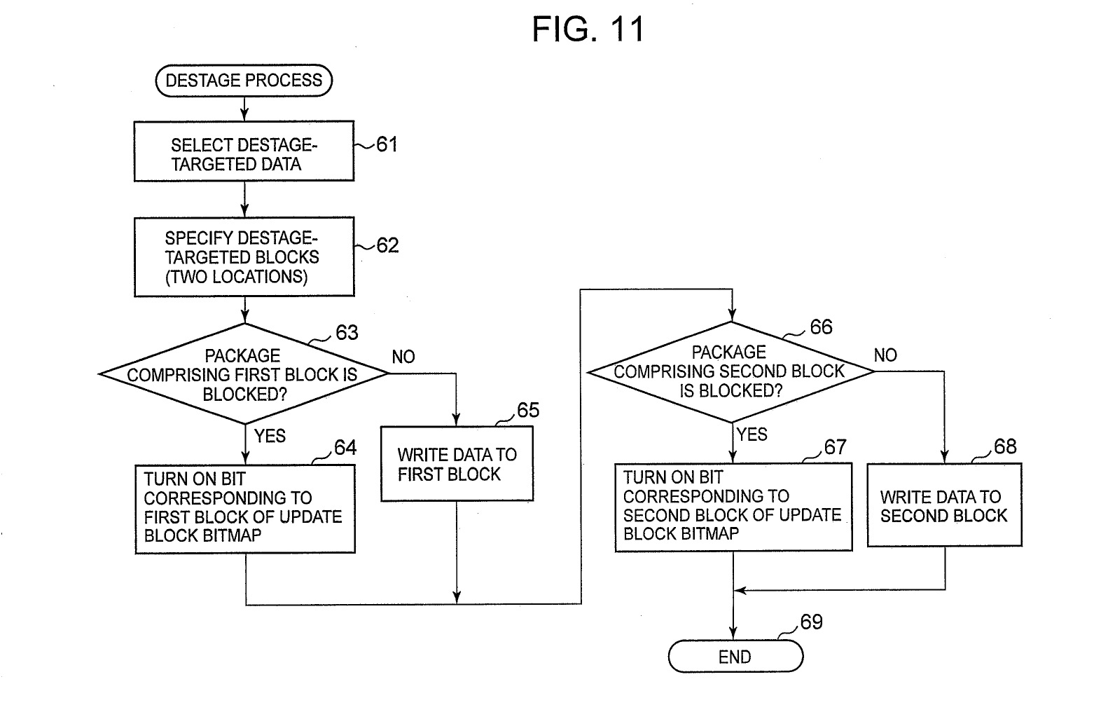

FIG. 11 shows a flowchart of a data write process to flash memory (destage process) comprising a process for recording an update location in this update block bitmap. First, the MP7 selects the data targeted for destaging (Step 61). Next, MP7 uses the block allocation table 14 to specify the physical blocks ID of the destage-targeted blocks (two locations) where data is to be stored from the destage-destination device numbers and addresses (Step 62).

Next, the MP7 determines whether or not the package comprising the first destage-targeted block is blocked (Step 63), and if this package is blocked, turns ON the bits corresponding to the first block of the update block bitmap (Step 64). If this package is not blocked, the MP7 writes the data to the first block (Step 65).

Next, the MP7 determines whether or not the package comprising the second destage-targeted block is blocked (Step 66), and if this package is blocked, turns ON the bits corresponding to the second block of the update block bitmap (Step 67). If this package is not blocked, the MP7 writes the data to the second block (Step 68).

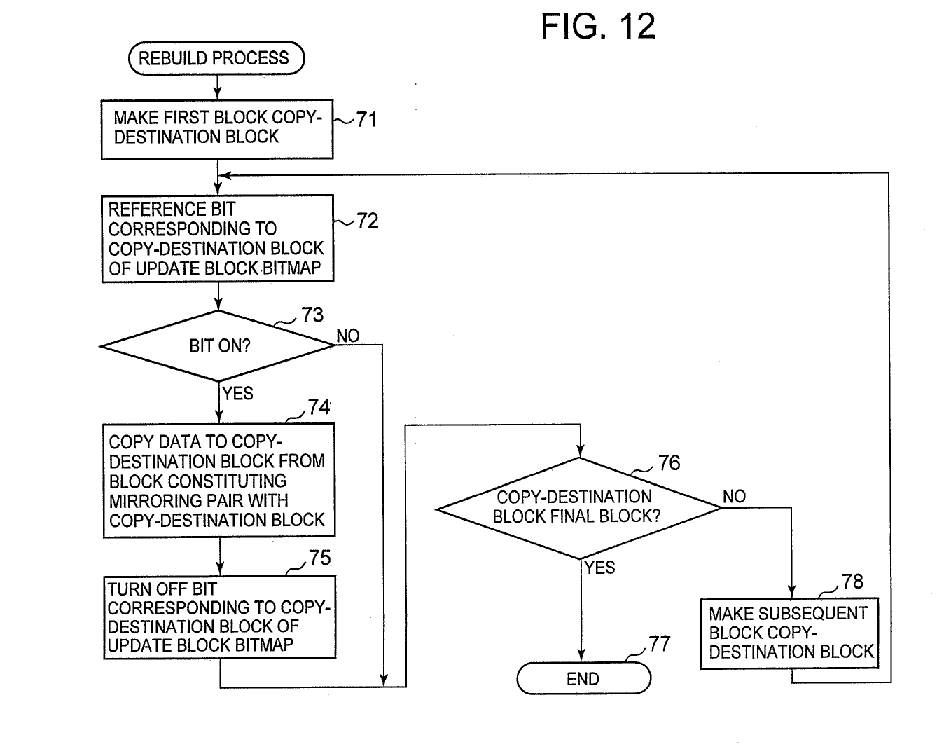

FIG. 12 is a flowchart of a rebuild process that uses the update block bitmap. First, the MP7 sets the first block comprised in the flash memory package that was augmented as the copy-destination block (Step 71). Then, the MP7 references the bit of the update block bitmap corresponding to the copy-destination block (Step 72). Next, the MP7 determines whether or not this bit is ON (Step 73), and if the bit is ON, the MP7 copies data to the copy-destination block from the block that constitutes the mirror pair relative to the copy-destination block (Step 74), and turns OFF the bit of the update block bitmap corresponding to the copy-destination block (Step 75). If the bit is OFF, the MP7 skips Step 74 and Step 75, and proceeds to Step 76. Next, the MP7 determines whether or not the current copy-destination block is the final block in the flash memory package (Step 76), and if the copy-destination block is the final block, ends the rebuild process (Step 77). If the copy-destination block is not the final block in the flash memory package, the MP7 sets the subsequent block as the copy-destination block (Step 78), returns to Step 72, and continues processing.

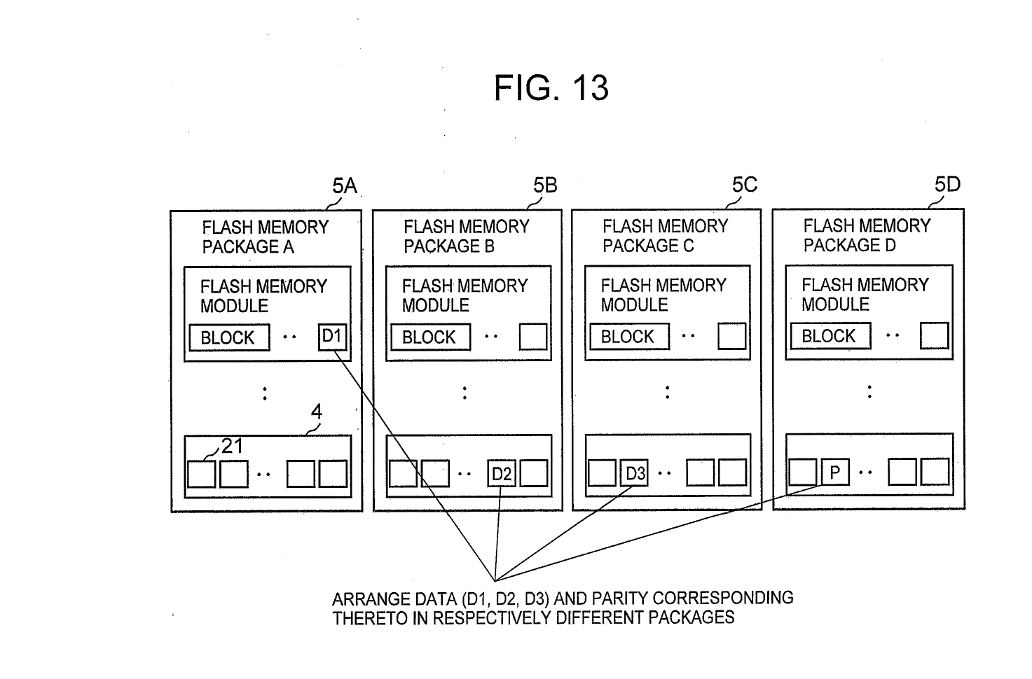

The preceding has described this embodiment in the case of RAID1, but the embodiments of the present invention are not limited to this, and, for example, can also utilize other RAID configurations such as RAID5, RAID6, and so on. For example, in the case of a RAID5 (3D+1P), data (D1, D2, D3) and the parity (P) corresponding thereto can be arranged in respectively different flash memory packages as in FIG. 13. Naturally, when carrying out a rebuild process, or when a read or write has been received from the host, unlike in RAID1, the data and parity are created using a parity operation.

Further, in this embodiment, a flash memory package is given as an example of an alternate block allocation range, but the embodiments of the present invention are not limited to this. Redundancy should be better than when the entire storage system is used as the allocation range, so the storage controller can split the storage system into a plurality of partitions using an arbitrary condition, and the allocation of an alternate block can be restricted solely to the inside of a partition. For example, it is also possible to set the scope of the power source boundary or storage device enclosure as the alternate block allocation range (that is, the partition).

Furthermore, in the first and second embodiments, the configuration is such that flash memory modules 4 are mounted in a flash memory package to facilitate the augmentation of flash memory in the storage system, but the embodiments of the present invention are not limited to this, and, for example, a configuration that stores the substrate on which the flash memory chip is mounted in a box-shaped memory cartridge, and connects this memory cartridge to the storage device can also be used.

In addition, in the first and second embodiments, cache memory 6 and main memory 8 are different memories, but the embodiments of the present invention are not limited to this, and, for example, data written in from the host, a program and control data can also be stored in the same memory.

What is claimed is:

1. A storage system, comprising:
a storage controller;
and one or a plurality of flash memory modules coupled to the storage controller,
wherein the one or the plurality of flash memory modules each have one or a plurality of flash memory chips,
the storage controller manages the status of a storage area in the flash memory chip of the one or the plurality of flash memory modules, and
when a portion of a storage area in the flash memory chip of the one or the plurality of flash memory modules becomes unwritable, the storage controller carries out control so as to use, as an alternate area for the portion of the storage area that has become unwritable, a free storage area from inside the flash memory chip of the one or the plurality of flash memory modules, and to store data that has been stored in the portion of the storage area that has become unwritable, in the alternate area.

2. The storage system according to claim 1, further comprising:
a flash memory package that has a plurality of connectors which are coupled to the storage controller and each of which is coupled to any of the one or the plurality of flash memory modules, and that has an LSI that controls access to the flash memory chip in the flash memory module, which is connected via the connector, and
when a new flash memory module is coupled to any of the plurality of connectors of the flash memory package, the storage controller selects the alternate area from among the storage areas in one or a plurality of flash memory chips of the new flash memory module.

3. The storage system according to claim 2, wherein the storage controller has a memory that records the status of the storage area in the flash memory chip of the one or the plurality of flash memory modules, and
when the new flash memory module is coupled to the flash memory package, the storage controller acquires information showing the status of the storage areas in one or a plurality of flash memory chips of the new flash memory module, and stores the information in memory.

4. The storage system according to claim 2, wherein the storage controller manages the total size of the free storage areas in the flash memory chip of the one or the plurality of flash memory modules, and
when the total size satisfies a predetermined condition, the storage controller outputs a warning to add a new flash memory module to the flash memory package.

5. The storage system according to claim 1, wherein the storage controller selects a free area from among the storage areas that satisfy a predetermined condition, and uses the free area as the alternate area for the portion of the storage area that has become unwritable.

6. The storage system according to claim 5, wherein the storage controller selects the alternate area from among the storage areas in the flash memory chip of the same flash memory module as the portion of the storage area that has become unwritable.

7. The storage system according to claim 1, wherein the storage controller splits the storage area in the flash memory chip of the one or the plurality of flash memory modules into a plurality of partitions, and selects the alternate area from among the free storage areas belonging to the same partition as a partition to which the portion of the storage area that has become unwritable belongs.

8. The storage system according to claim 7, wherein the storage controller manages the total size of the free storage areas in the partition for the each partition.

9. The storage system according to claim 1, comprising a plurality of flash memory modules, wherein the storage controller uses the plurality of flash memory modules to configure a RAID group.

10. The storage controller according to claim 9, comprising:
a plurality of flash memory packages each having a connector which is coupled to the storage controller and is coupled to any of the plurality of flash memory modules, and an LSI that controls access to the flash memory chip in the flash memory module coupled to the connector,
wherein the storage controller uses the plurality of flash memory modules coupled to respectively different flash memory packages to configure the RAID group.

11. The storage system according to claim 1, wherein the storage controller is coupled to a management server, and
the storage controller manages the total size of the free storage areas in the flash memory chip of the one or the plurality of flash memory modules, and outputs to the management server information showing the total size.

12. The storage system according to claim 11, wherein the storage controller further manages the total size of the storage areas in use in the flash memory chip of the one or the plurality of flash memory modules, and the total size of the storage areas that have become unwritable, and outputs to the management server information showing the total size of the storage areas in use and the total size of the storage areas that have become unwritable.
